(19) United States
(12) Patent Application Publication
(10) Pub. No.: US 2016/0049680 A1
(43) Pub. Date: Feb. 18, 2016

(54) ELECTROCHEMICAL CELL HAVING A PLURALITY OF ELECTROLYTE FLOW AREAS

(71) Applicant: UniEnergy Technologies, LLC, Mukilteo, WA (US)

(72) Inventors: Qingtao Luo, Mukilteo, WA (US); Liyu Li, Bellevue, WA (US); Lijun Bai, Spokane, WA (US); Jinfeng Wu, Mukilteo, WA (US); Richard Winter, Orinda, CA (US)

(73) Assignee: UniEnergy Technologies, LLC, Mukilteo, WA (US)

(21) Appl. No.: 14/825,078

(22) Filed: Aug. 12, 2015

Related U.S. Application Data
(60) Provisional application No. 62/036,546, filed on Aug. 12, 2014.

(51) Int. Cl. H01M 8/18; H01M 8/02; H01M 8/20

(52) U.S. Cl. CPC H01M 8/188; H01M 8/20; H01M 8/0258

(57) ABSTRACT

In one embodiment of the present disclosure, an electrochemical cell includes a positive portion including a cathode and a catholyte half-cell and a negative portion including an anode and an anolyte half-cell, wherein at least one of the catholyte half-cell and the anolyte half-cell has a plurality of electrolyte flow areas; an ion transfer membrane separating the positive portion and the negative portion; and at least one positive current collector in contact with the cathode and at least one negative current collector in contact with the anode.

### CROSS-REFERENCE TO RELATED APPLICATION

This application claims the benefit of U.S. Provisional Application No. 62/036,546, filed Aug. 12, 2015, the disclosure of which is expressly incorporated by reference herein in its entirety.

### BACKGROUND

Concerns over the environmental consequences of burning fossil fuels have led to an increasing use of renewable energy generated from sources such as solar and wind. The intermittent and varied nature of such renewable energy sources, however, has made it difficult to fully integrate these energy sources into existing electrical power grids and distribution networks. A solution to this problem has been to employ large-scale electrical energy storage (EES) systems. These systems are widely considered to be an effective approach to improve the reliability, power quality, and economy of renewable energy derived from solar or wind sources.

In addition to facilitating the integration of renewable wind and solar energy, large scale EES systems also may have the potential to provide additional value to electrical grid management, for example: resource and market services at the bulk power system level, such as frequency regulation, spinning reserves, fast ramping capacity, black start capacity, and alternatives for fossil fuel peaking systems; transmission and delivery support by increasing capability of existing assets and deferring grid upgrade investments; micro-grid support; and peak shaving and power shifting.

Among the most promising large-scale EES technologies are redox flow batteries (RFBs). RFBs are special electrochemical systems that can repeatedly store and convert megawatt-hours (MWhs) of electrical energy to chemical energy and chemical energy back to electrical energy when needed. RFBs are well-suited for energy storage because of their ability to tolerate fluctuating power supplies, bear repetitive charge/discharge cycles at maximum rates, initiate charge/discharge cycling at any state of charge, design energy storage capacity and power for a given system independently, deliver long cycle life, and operate safely without fire hazards inherent in some other designs.

In simplified terms, an RFB electrochemical cell is a device capable of either deriving electrical energy from chemical reactions, or facilitating chemical reactions through the introduction of electrical energy. In general, an electrochemical cell includes two half-cells, each having an electrolyte. The two half-cells may use the same electrolyte, or they may use different electrolytes. With the introduction of electrical energy, species from one half-cell lose electrons (oxidation) to their electrode while species from the other half-cell gain electrons (reduction) from their electrode.

Multiple RFB electrochemical cells electrically connected together in series within a common housing are generally referred to as an electrochemical “stack”. Multiple stacks electrically connected together are generally referred to as a “string”. Multiple stings electrically connected together are generally referred to as a “site”.

A common RFB electrochemical cell configuration includes two opposing electrodes separated by an ion exchange membrane or other separator, and two circulating electrolyte solutions, referred to as the “anolyte” and “catholyte”. The energy conversion between electrical energy and chemical potential occurs instantly at the electrodes when the liquid electrolyte begins to flow through the cells.

To meet industrial demands for efficient, flexible, rugged, compact, and reliable large-scale ESS systems with rapid, scalable, and low-cost deployment, there is a need for improved RFB systems. Cell and cell stack design improvements can be particularly important because they can have a large impact on system efficiency and reliability. These improvements are often initiated at a small scale in laboratory settings and scaled up for product deployments, but in many cases, a decrease in performance is seen between small scale electrochemical cells and larger scale electrochemical cells. This phenomenon is called the “scale-up effect”. Embodiments of the present disclosure are directed to more rapid and higher-performing product-scale design improvements.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an electrochemical cell is provided. The cell includes a positive portion including a cathode and a catholyte half-cell and a negative portion including an anode and an anolyte half-cell, wherein at least one of the catholyte half-cell and the anolyte half-cell has a plurality of electrolyte flow areas; and an ion transfer membrane separating the positive portion and the negative portion.

In accordance with another embodiment of the present disclosure, an electrochemical cell is provided. The cell includes a positive portion including a cathode and at least one catholyte flow area; a negative portion including an anode and at least one anolyte flow area; and an ion transfer membrane separating the catholyte and anolyte half-cells, wherein at least one of the catholyte and anolyte half-cells includes a plurality of electrolyte flow areas; and at least one positive current collector in contact with the cathode and at least one negative current collector in contact with the anode.

In accordance with another embodiment of the present disclosure, an electrochemical stack including at least first and second electrochemical cells is provided. Each electrochemical cell includes a positive portion including a cathode and at least one catholyte flow area; a negative portion including an anode and at least one anolyte flow area; and an ion transfer membrane separating the catholyte and anolyte half-cells, wherein at least one of the catholyte and anolyte half-cells includes a plurality of electrolyte flow areas.

In accordance with another embodiment of the present disclosure, a method of operating an electrochemical cell is provided. The method includes flowing catholyte in a catholyte half-cell and flowing anolyte in an anolyte half-cell, wherein at least one of the catholyte and anolyte flow areas includes a plurality of electrolyte flow areas; separating the catholyte and anolyte flow areas of the catholyte and anolyte half-cells using an ion transfer membrane; and collecting current from the electrochemical cell.

In any of the embodiments described herein, both of the catholyte half-cell and the anolyte half-cell may have a plurality of electrolyte flow areas.

In any of the embodiments described herein, at least a portion of the plurality of electrolyte flow areas may be in parallel configuration.

In any of the embodiments described herein, each of the plurality of flow areas may be in fluidic contact with a portion of the cathode or anode and a portion of the ion transfer membrane.

In any of the embodiments described herein, at least a portion of the plurality of electrolyte flow areas may be defined by a frame structure.

In any of the embodiments described herein, the frame structure may extend from the anode or cathode to the ion transfer membrane in either the catholyte or anolyte half-cell.

In any of the embodiments described herein, the frame structure may be made from a non-conductive material.

In any of the embodiments described herein, at least a portion of the plurality of electrolyte flow areas may be defined by the shape of a porous material.

In any of the embodiments described herein, the porous material is selected from the group consisting of carbon felt or carbon foam.

In any of the embodiments described herein, the shape of the porous carbon material may be determined by slots or other cuts that are non-continuous.

In any of the embodiments described herein, the electrochemical cell may have a length and a width and the electrolyte flow distance in each of the electrolyte flow areas may be a portion of the shortest of the length and/or width of the electrochemical cell.

In any of the embodiments described herein, the electrochemical cell may have a radius and the electrolyte flow distance in each of the electrolyte flow areas may be a portion of the radius of the electrochemical cell.

In any of the embodiments described herein, the plurality of electrolyte flow areas may be fluidly separated from each other, each having discrete inlets and outlets.

In any of the embodiments described herein, the plurality of electrolyte flow areas may not be fluidly separated from each other.

In any of the embodiments described herein, the inlets and outlets to the plurality of electrolyte flow areas may be located inside the electrochemical cell.

In any of the embodiments described herein, the inlets and outlets to the plurality of electrolyte flow areas may be located outside the electrochemical cell.

In any of the embodiments described herein, the width to length ratio of each electrolyte flow area may be in the range of 2:1 to 100:1.

In any of the embodiments described herein, the number of electrolyte flow areas in the catholyte flow chamber or the anolyte flow chamber may be in the range of 2 to 100.

In any of the embodiments described herein, further comprising an anolyte delivery manifold configured to distribute liquid anolyte to the first and second electrochemical cells.

In any of the embodiments described herein, further comprising an anolyte return manifold configured to accept liquid anolyte after passing through the first and second electrochemical cells.

In any of the embodiments described herein, further comprising a catholyte delivery manifold configured to distribute liquid catholyte to the first and second electrochemical cells.

In any of the embodiments described herein, further comprising a catholyte return manifold configured to accept liquid catholyte after passing through the first and second electrochemical cells.

In any of the embodiments described herein, the first and second electrochemical cells may be electrically connected in series.

In any of the embodiments described herein, the first and second electrochemical cells may be arranged fluidically in parallel.

### DESCRIPTION OF THE DRAWINGS

The foregoing aspects and many of the attendant advantages of this disclosure will become better understood by reference to the following detailed description, when taken in conjunction with the accompanying drawings, wherein:

FIG. 1 is an isometric view of a redox flow battery (RFB) module in accordance with one embodiment of the present disclosure;

FIG. 2 is a schematic view of various components of the RFB module of FIG. 1;

FIGS. 3 and 4 are schematic views comparing an electrochemical cell in accordance with a previously designed electrochemical cell and in accordance with one embodiment of the present disclosure;

FIGS. 5 and 6 are data representations of the scale-up effect in previously designed systems;

FIG. 7 is a representative schematic view of the concentration of reactants in the bulk solution and at the diffusion layer present in flow battery cell designs;

FIGS. 8 and 9 are a schematic and data relating to an electrochemical cell including four parallel flow electrolyte distribution zones, in accordance with one embodiment of the present disclosure;

FIGS. 10 and 11 are a schematic and an isometric view of an electrochemical cell including three parallel flow electrolyte distribution zones, in accordance with one embodiment of the present disclosure;

FIG. 12 is a schematic of an electrochemical cell including multiple parallel flow distribution zones in accordance with another embodiment of the present disclosure; and

FIG. 13 is a schematic of an electrochemical cell including multiple radial flow distribution zones in accordance with another embodiment of the present disclosure.

### DETAILED DESCRIPTION

Embodiments of the present disclosure are directed to cell and cell stack designs that use multiple electrolyte flow paths within a single large cell to replicate the performance of small-scale cell designs, resulting in improved full-scale system operational performance.

In some embodiments of the present disclosure, the flow electrochemical energy systems may be described in the context of a vanadium redox flow battery (VRFB), wherein a V³⁺/V²⁺ sulfate solution serves as the negative electrolyte (“anolyte”) and a V⁵⁺/V⁴⁺ sulfate solution serves as the positive electrolyte (“catholyte”). It is to be understood, however, that other redox chemistries are contemplated and within the scope of the present disclosure, including, as non-limiting examples, V²⁺/V³⁺ vs. Br⁻/ClBr₂, Br₂/Br⁻ vs. S/S²⁻, Br⁻/Br₂ vs. Zn²⁺/Zn, Ce⁴⁺/Ce³⁺ vs. V²⁺/V³⁺, Fe³⁺/Fe²⁺ vs. Br₂/Br⁻, Mn²⁺/Mn³⁺ vs. Br₂/Br⁻, Fe³⁺/Fe²⁺ vs. Ti²⁺/Ti⁴⁺, etc.

Although shown and described with reference to a redox flow battery system, it should be appreciated that the scale-up and operational concepts for cell and cell stack designs described herein are not limited to those used in RFBs. They may also be used in any system having a plurality of electrochemical cells such as fuel cells.

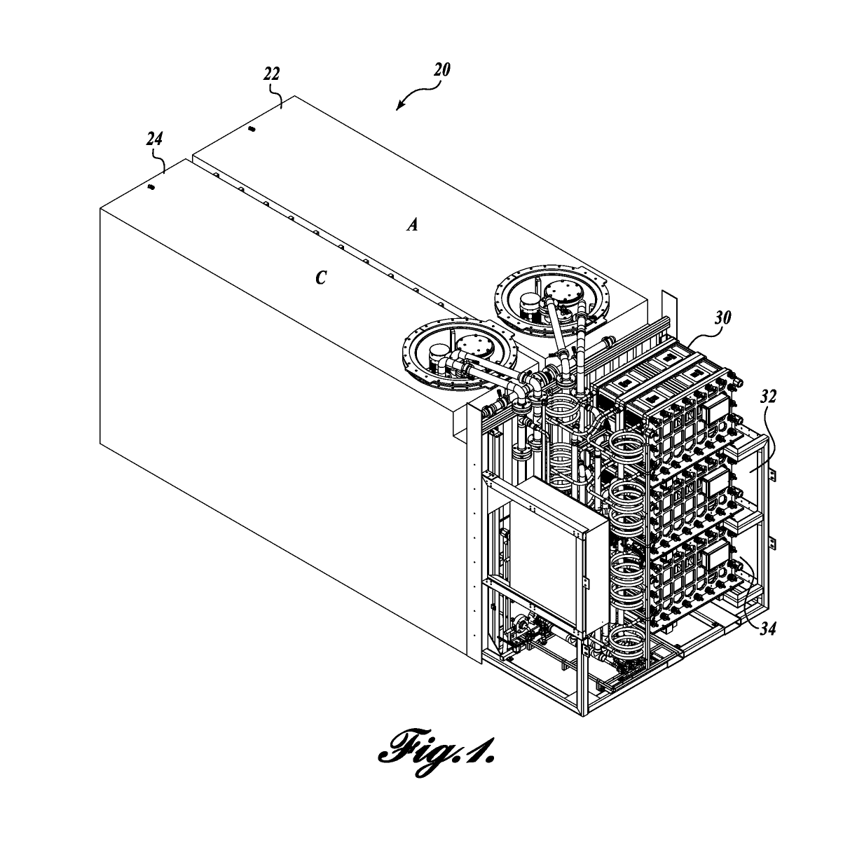

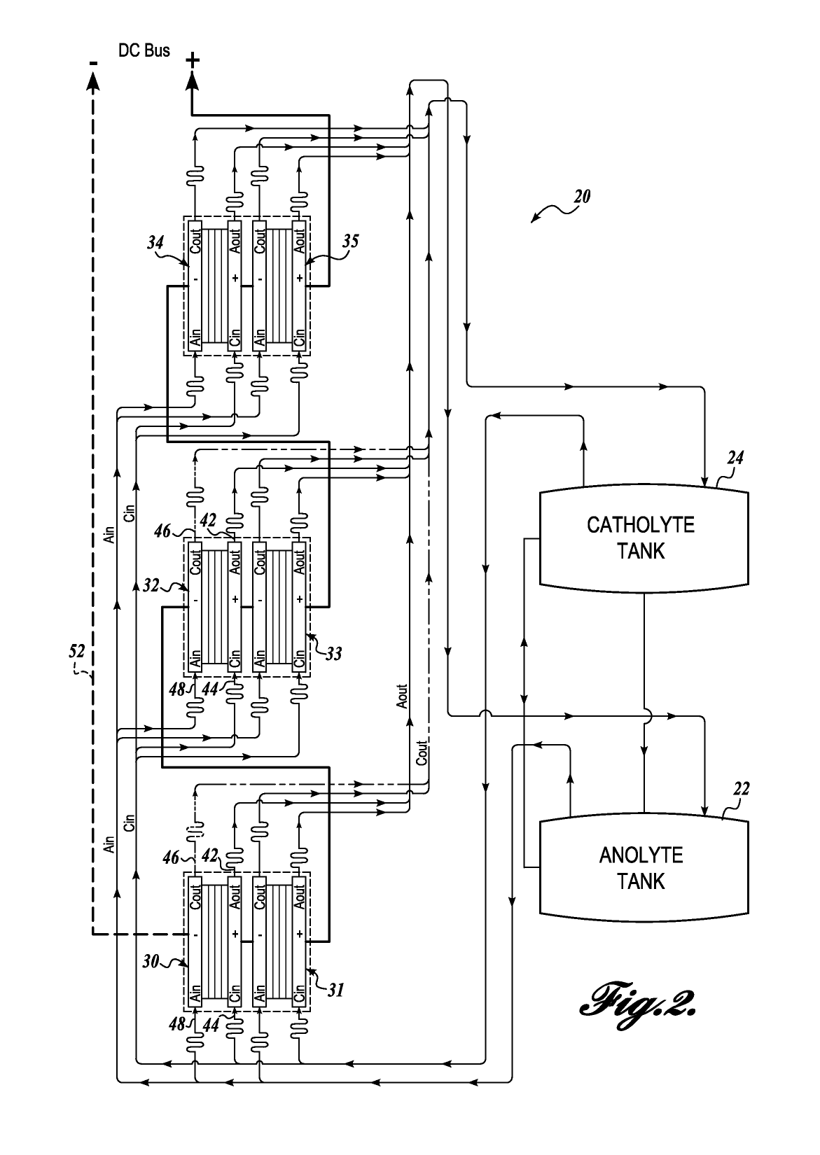

Referring to the system drawing and system schematic in FIGS. 1 and 2, general operation of the redox flow battery system 20 will be described. The redox flow battery system 20 operates by circulating the anolyte and the catholyte from respective tanks 22 and 24 into the electrochemical cells, e.g., 30 and 32. The cells 30 and 32 operate to discharge or store energy as directed by power and control elements in electrical communication with the electrochemical cells 30 and 32. In one mode (sometimes referred to as the “charging” mode), power and control elements, connected to a power source, operate to store electrical energy as chemical potential in the catholyte and anolyte. The power source can be any power source known to generate electrical power, including renewable power sources, such as wind, solar, and hydroelectric. Traditional power sources, such as combustion, can also be used.

In a second (“discharge”) mode of operation, the redox flow battery system 20 is operated to transform chemical potential stored in the catholyte and anolyte into electrical energy that is then discharged on demand by power and control elements that supply an electrical load.

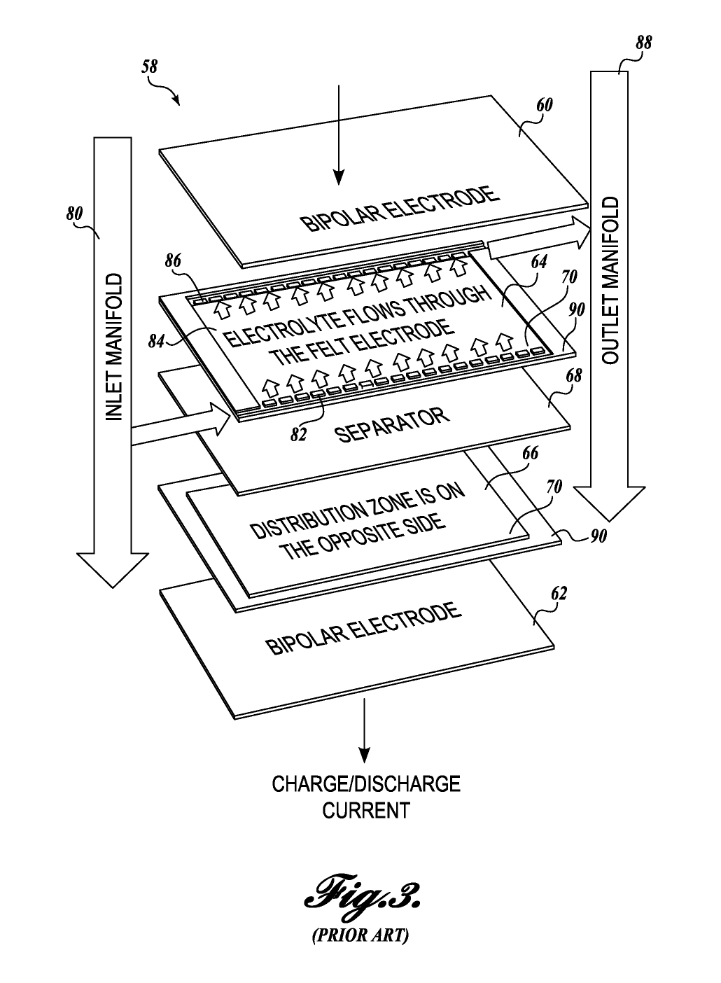

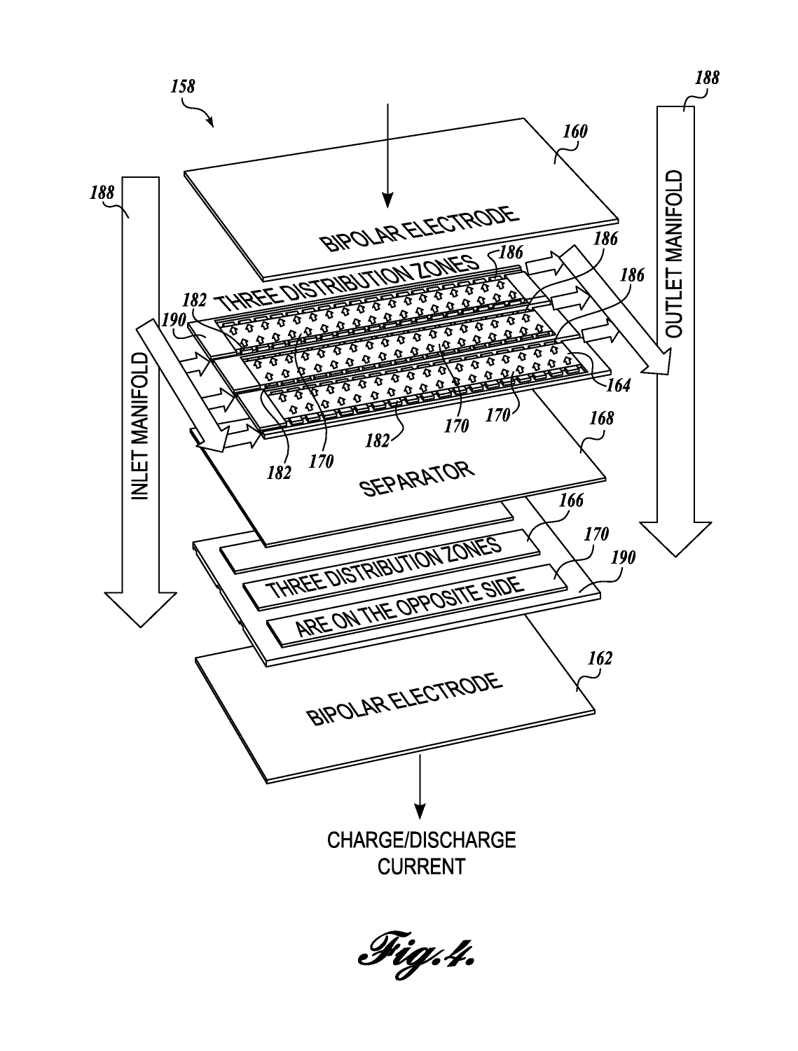

Referring to FIG. 3, a single electrochemical cell element 58 in the system 20 includes the following elements assembled in series: a positive electrode 60, at least one catholyte half-cell 64, an ion transfer membrane 68, at least one anolyte half-cell 66, and a negative electrode 62. The catholyte and anolyte half-cells 64 and 66 comprise one or more flow areas, also referred to as active electrode areas or reaction zones 70 (see also FIG. 4 reaction zones 170). In the cell element 58 of FIG. 3, the flow areas or reaction zones 70 in each half-cell 64 or 66 are defined by a frame 90. A porous conductive material 84 such as carbon foam or carbon felt typically is included in the reaction zone 70 to increase performance.

The ion transfer membrane 68 separates the electrochemical cell into a positive side and a negative side. Selected ions (e.g., H+) are allowed to transport across the ion transfer membrane 68 as part of the electrochemical charge and discharge process. The positive and negative electrodes 60 and 62 are configured to cause electrons to flow along an axis normal to the ion transfer membrane 68 during electrochemical cell charge and discharge (see, e.g., line 52 shown in FIG. 2).

As can be seen in FIG. 2, common fluid inlets 44 and 48 and outlets 42 and 46 are configured to allow integration of an electrochemical cell 30 into the redox flow battery system 20.

To obtain high voltage/power systems, a plurality of single electrochemical cells may be assembled together in series to form a stack of electrochemical cells 30 (referred to herein as a “stack,” a “cell stack,” or an “electrochemical cell stack”). Several cell stacks 30, 31, 32, 33, 34, 35 (see FIG. 2) may then be further assembled together to form a battery system 20. A MW-level RFB system can be created and generally has a plurality of cell stacks, for example, with each cell stack having more than twenty electrochemical cells. As described for individual electrochemical cells, the stack is also arranged with positive and negative current collectors that cause electrons to flow through the cell stack along an axis normal to the ion transfer membranes and current collectors during electrochemical charge and discharge (see, e.g., line 52 shown in FIG. 2).

As noted above and shown in FIG. 2, a stack 30 includes repeating single cell elements 58 (see FIGS. 3 and 4 for exemplary single cell elements). In the illustrated embodiment of FIG. 3, the positive electrode 60 and negative electrode 62 of the cell 58 are formed by first and second bipolar electrodes that are electrically conductive and liquid impermeable to block liquid transport from cell to cell. Each bipolar electrode has an electrically positive first side and an electrically negative second side. In other embodiments, either or both of the positive and negative electrodes may not be bipolar electrodes. In one non-limiting example, a porous material 84 such as carbon felt or carbon foam may be situated in active electrode area 70 of the anolyte and catholyte half-cells 64 and 66 to facilitate electrochemical reactions and reduce cell resistance during the charge/discharge process.

When individual cells 58 are assembled in series to form a stack, the first (positive) side of the first bipolar electrode 60 forms the flow area of the catholyte half-cell 64 with the second side of an ion exchange membrane 68 and the second (negative) side of the second bipolar electrode 62 forms the flow area of the anolyte half-cell 66 with the first side of the ion exchange membrane 68.

As seen in FIG. 3, electrolyte flows from the inlet manifold 80 into the cell inlet electrolyte distribution zone 82 of the respective anolyte or catholyte half-cells 64 or 66. Electrolyte then flows through the porous material 84 across the active electrode area 70 to the cell outlet electrolyte distribution zone 86 and out to the outlet manifold 88. In one non-limiting example, the distance the electrolyte flows in a full-scale system across the electrode is approximately 50 cm.

Typically, development and testing of full-scale cells and cell stacks like those described herein, start with smaller test cells, however, successful smaller scale tests do not always result in successful full-scale operating performance. Experiments, described in EXAMPLE 1, were conducted to understand the causal relationship between small and large scale performance results, also known as the scale-up effect.

### Scale-Up Effect

In one example, a small single test cell was prepared as shown in FIG. 3 and the table below. The active area measured 8 cm across by 6 cm in the direction of electrolyte flow, the electrolyte flow rate through both the anolyte flow area 70 and catholyte flow area 70 was 0.617 cm/s, the charge/discharge current density varied between 85 and 155 mA/cm2 over the active area, and the operating temperature was maintained at 45 C. The small cell also included 3.6 mm thick carbon felt 84 in the anolyte and catholyte flow areas 70. Similarly, a large scale stack was also prepared as shown in FIG. 3 and the table below, where the active electrode area 70 for each cell measured 50 cm in the direction of electrolyte flow by 80 cm across. The electrolyte flow rate through both the anolyte and catholyte flow areas 70 was 0.641 cm/s, the charge/discharge current density over the active electrode areas 70 varied between 85 and 155 mA/cm2, and the operating temperature was maintained at 45 C-48 C. The large cells included 3.75 mm thick felt in the anolyte and catholyte flow areas 70.

Comparative data for an exemplary large stack and single cell having a single reaction zone or electrolyte flow area are provided below.

| | Large stack | Single Cell |
|---|---|---|
| Thickness of felt | 3.75 mm z felt | 3.6 mm z felt |
| Electrolyte | Standard electrolyte | Standard electrolyte |
| Dimensions of cell | 80 cm by 50 cm | 6 cm by 8 cm |
| Number of cells | 52 cells | 1 cell |
| Flow rate through cell | 60 L/min (0.641 cm/s) | 80 ml/min (0.617 cm/s) |
| Current density | 85 mA/cm2 to | 85 mA/cm2 to |
| | 155 mA/cm2 | 155 mA/cm2 |
| Temperature | 45 C. to 48 C. | 45 C. |

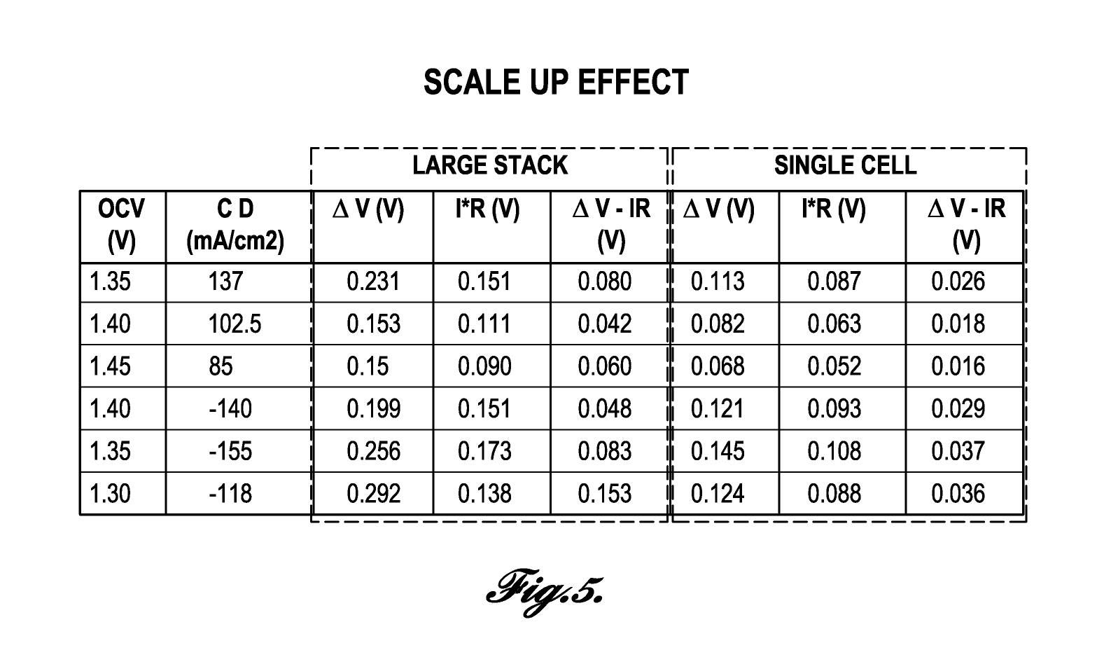

System variables used in FIG. 5 are described below.

OCV (open circuit voltage)—This value measures the voltage potential between the anolyte and catholyte, and is a good indicator of the state of charge of the cell as it is charged or discharged.

CD (current density)—This value measures the charge or discharge electrical current density per unit area of the active electrode surface area (mA/cm2).

ΔV—This measures the voltage difference between OCV and cell voltage during charge or discharge operations when current is applied to the cell.

I*R—This value is the charge/discharge current applied to the active area of the cell multiplied by the measured resistance of the assembled cell.

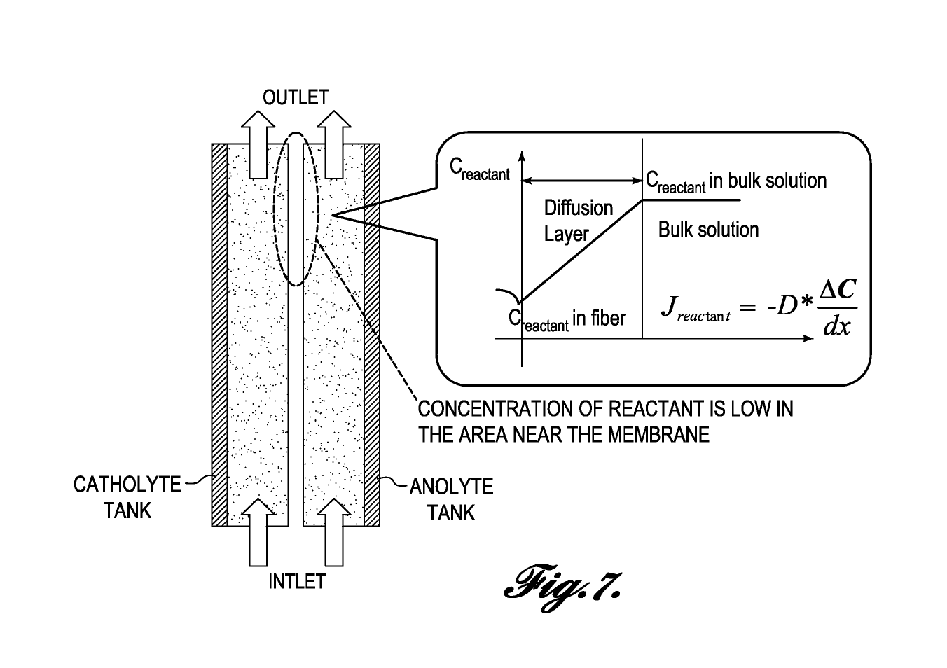

ΔV−IR—This value, known as concentration polarization, relates the concentration of reactants available in the bulk electrolyte solution and the diffusion layer thickness that exists near the ion exchange membrane (see FIG. 7) to flow speed and other cell physical and operating parameters. This value provides a measure of cell performance for a given set of operating conditions, primarily governed by flow speed, flow distance, and current density over the active electrode area 70.

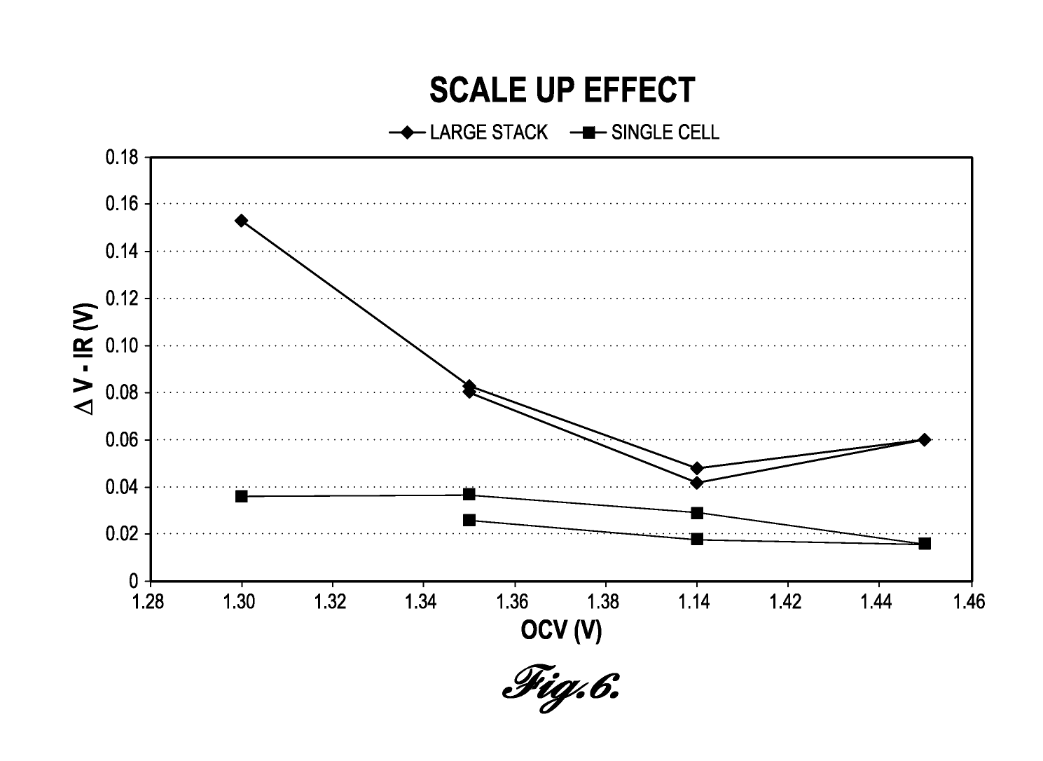

Scale-up results from experimental analysis are shown in FIGS. 5 and 6, where for a given current density (mA/cm2) and electrolyte flow rate (ml/min/cm2) over an active electrode area 70, the single cell outperformed the large stack having lower concentration polarization over the whole operating range (1.3V-1.45V OCV). This performance difference between the single cell and the large stack indicates that the distance the electrolyte flows is a major determinant of cell performance. If the reactants in the electrolyte are consumed before the end of the flow path is reached, there is a decrease in cell performance. If there are excess reactants left at the end of the electrolyte flow path, there may be excess flow and excess pumping losses associated with a less efficient cell or cell stack.

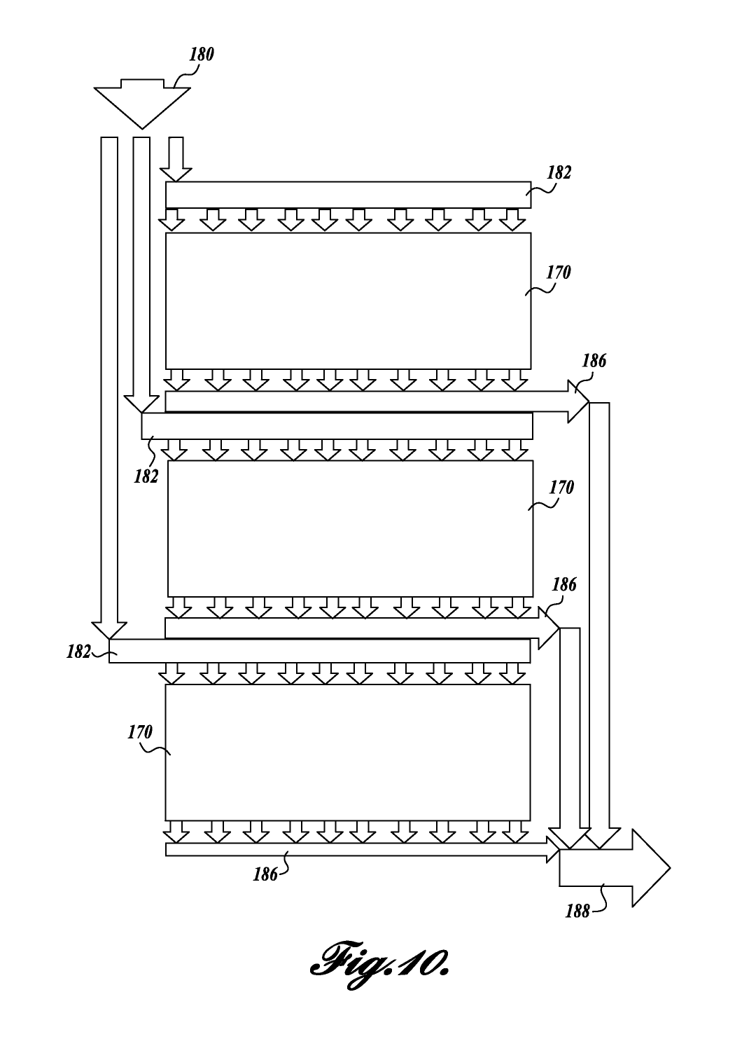

One approach to mitigating the scale-up effect is to produce large-scale cells that subdivide and direct flow patterns to simulate the uniform flow characteristics of smaller cells by maintaining similar flow path lengths and electrolyte flow speed without greatly increasing electrolyte pumping losses. For example, as shown in FIGS. 4, 10, 12, and 13, a single large cell may be subdivided into more than one region (sub-cell) with shorter flow paths across the active electrode area. Testing with this arrangement showed electrolyte concentration polarization for a large cell assembly having a plurality of sub-cells arranged in parallel produced performance results similar to that of a single cell.

### Multiple Flow Paths in a Large Cell

As described above, electrolyte flow path configurations and flow speeds are typically designed to optimize cell electrolytic reactions and electrolyte utilization for a given electrical current density across the surface of the electrode (mA/cm2), while minimizing cell electrical resistance and mechanical flow losses. One advantage of the configuration in FIG. 4 as compared to the configuration in FIG. 3 is that with three reaction zones 170, electrolyte flow distance is a maximum of one-third the distance over the active electrode area. As a non-limiting example, the electrolyte flow distance over the active electrode area in the large cell of FIG. 3, measured from the inlet electrolyte distribution zone 82 to the outlet electrolyte distribution zone 86 may be about 50 cm. In contrast, the electrolyte flow distance over the active electrode area in FIG. 4, measured from one of the three inlet electrolyte distribution zones 182 to the outlet electrolyte distribution zones 186 may be about 12 cm.

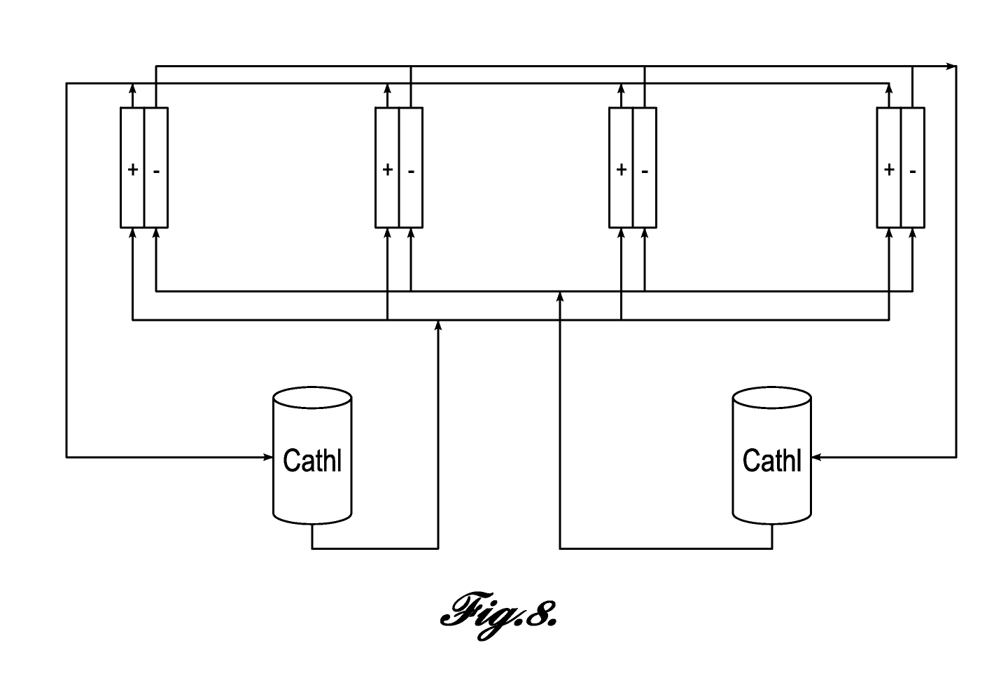

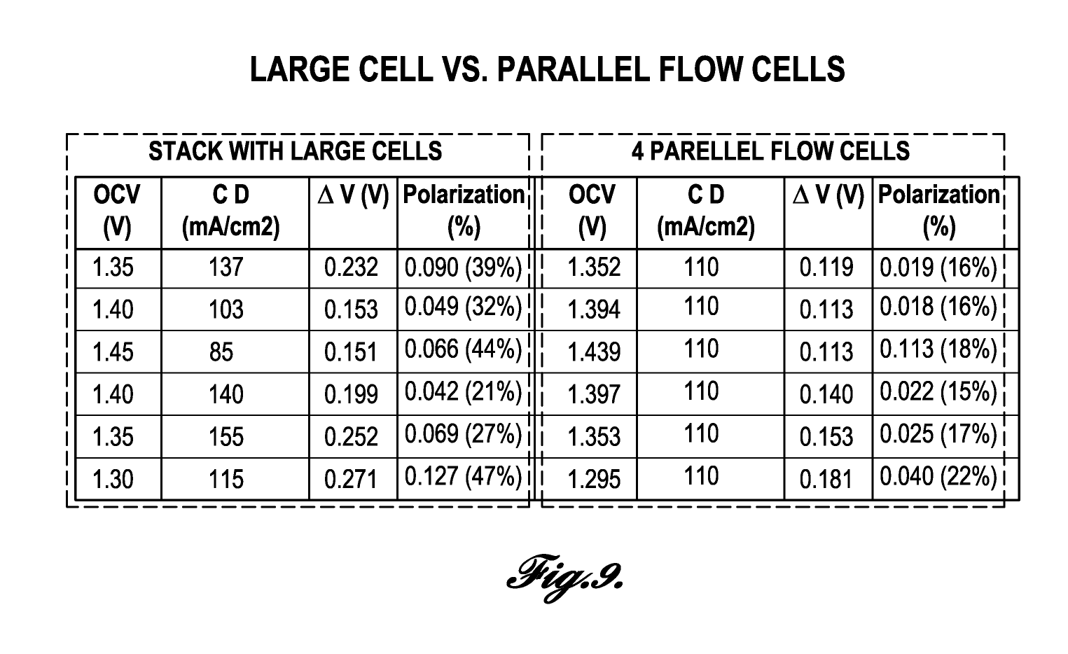

In another parallel flow embodiment shown in FIG. 8, there are four parallel flow areas, and the electrolyte flow distance over the active electrode area, measured from one of the four inlet electrolyte distribution zones to the outlet electrolyte distribution zones may be about 8 cm. The data provided in FIG. 9 shows that the electrolyte concentration polarization of four parallel flow cells is significantly less than the electrolyte concentration polarization of a single cell large cell. In fact, the polarization results for a large cell divided into four parallel flow areas are similar to the results of the single small-scale cell results shown in FIG. 5.

Many simultaneous variables, including but not limited to electrolyte flow speed, electrolyte concentration, charge/discharge electrical current density, material selection, and separator material, may contribute to cell performance, thus making it difficult and expensive to digitally model and make analytic performance predictions. Similarly, it is very costly and time consuming to produce full-scale experimental cells to complete design iterations. Therefore, there is a need to develop full scale cell designs that correlate directly to smaller experimental cells that are simpler, faster, and cheaper to design, build, and test so that design improvements can be quickly validated and implemented in full scale products.

Results shown in FIG. 9 validate an approach that divides a large cell into multiple flow areas. Design examples are described in detail below.

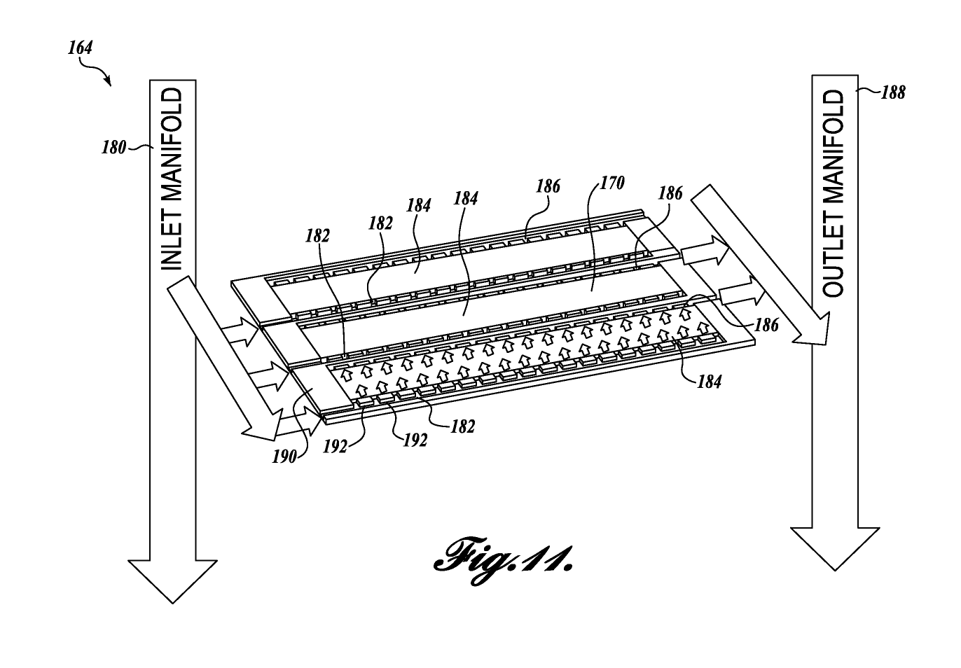

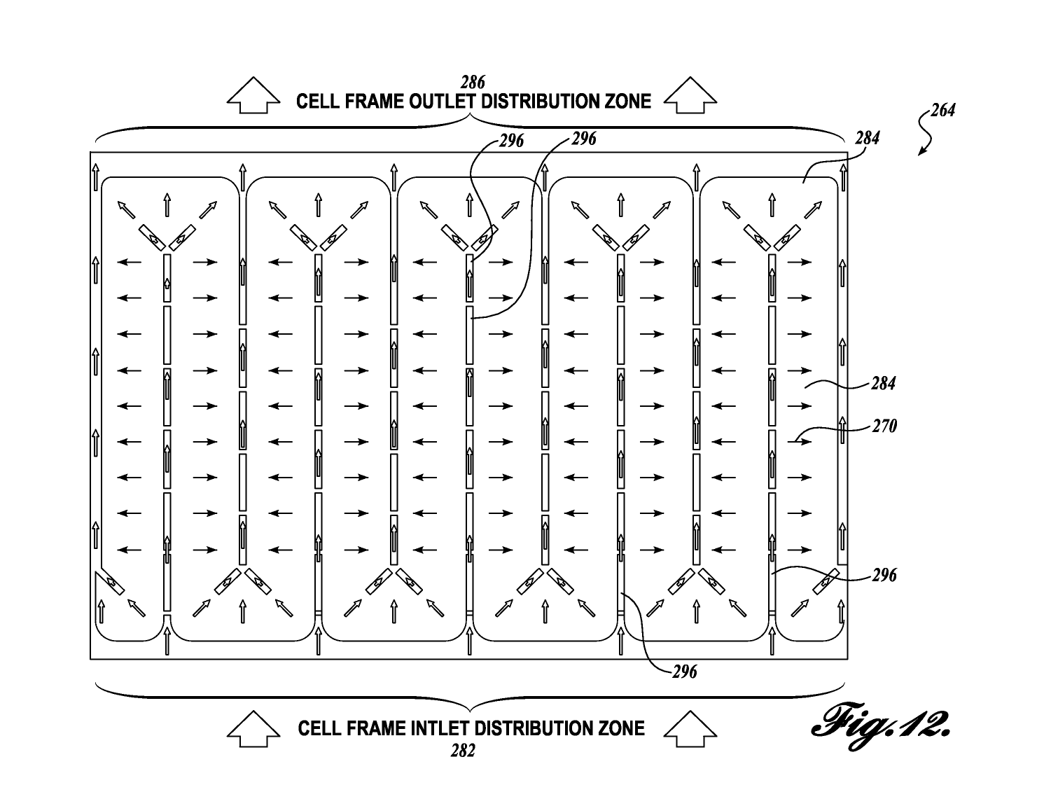

In the comparative systems of FIGS. 3 and 4, electrolyte flow is directed according to the cell frame design. In one non-limiting example, the electrolyte flow paths are directed by channels or other geometric features that are part of the cell frame, for example molded plastic parts (see, e.g., FIG. 11). In another non-limiting example, electrolyte distribution in the anolyte and catholyte electrolyte flow channels 64 and 66 can be defined by structures or channels cut into the carbon felt 84 (see, e.g., FIG. 12), or by some combination of these methods.

As can be seen in FIG. 4, one embodiment of the present disclosure is directed to anolyte and catholyte cells having a plurality of electrolyte inlet and outlet distribution zones 182 and 186 feeding the catholyte and anolyte flow areas 170. In the illustrated embodiment of FIG. 4 (see also FIG. 11), each of the catholyte and anolyte cells 164 and 166 include three substantially parallel discrete inlet distribution zones 182 from the inlet manifold 180 and three substantially parallel discrete outlet distribution zones 186 to the outlet manifold 188.

Each electrolyte flow area 170 in the catholyte half-cell 164 is in fluidic contact with a portion of the cathode 160 and a portion of the ion transfer membrane 168. Further, each electrolyte flow area 170 in the anolyte flow chamber is in fluidic contact with a portion of the anode 162 and a portion of the ion transfer membrane 168.

In the illustrated embodiment of FIG. 4, each flow area 170 is substantially separated from the others so that substantial amounts of fluids do not pass between adjacent flow areas 170. In other embodiments (see e.g., FIG. 12), the flow areas may not be separated.

In one embodiment, the inlets and outlets to the flow areas 170 may be located inside the electrochemical cell 158. In another embodiment, they may be located outside the electrochemical cell 158.

Referring to FIG. 11, in a close-up view of one of the catholyte half-cell 164 of FIG. 4, flow areas 170 are defined by a frame 190 including a plurality of electrolyte distribution zones for each flow area 170 in the catholyte half-cell 164. The flow areas 170 each have a flow distance less than the distance of the shortest dimension of the catholyte and anolyte half-cells 164 and 166. In the illustrated embodiment of FIG. 11, the flow distance is about ⅓ of the width of the catholyte and anolyte channels 164 and 166 (less when accounting for flow distribution areas).

The frame 190 may be non-conductive, for example, molded from plastic or another suitable material. The frame 190 may extend from the cathode 60 or anode 62 to the ion-transfer membrane 68.

In the illustrated embodiment of FIG. 11, the frame 190 includes three flow areas 170 and three cell inlet electrolyte distribution zones 182 configured to receive electrolyte from the inlet manifold 180. The frame 190 further includes three cell outlet electrolyte distribution zones 186 configured to deliver outlet electrolyte to the outlet manifold 188. At each cell inlet electrolyte distribution zone 182 and cell outlet electrolyte distribution zone 186, the frame 190 further includes a plurality of dividers 192 to create flow uniformity through each reaction zones 170. Carbon felt 184 or another suitable reaction zone material is sized to fit in each of the reaction zones 170.

The same or similar configuration can be used for the anolyte cell 166 shown in FIG. 4.

Although shown as including three flow channels 170 in the illustrated embodiment of FIG. 4, more or less flow channels are within the scope of the present disclosure. For example, in the illustrated embodiment of FIGS. 8 and 9 includes four cell inlet electrolyte distribution zones 282 and four cell outlet electrolyte distribution zones 286 in a substantially parallel configuration. Although shown in a parallel configuration, reaction zones need not be parallel with one another.

Moreover, although shown as having similar or the same flow areas 170 in the illustrated embodiments, the cathode half-cell and anode half-cell flow areas need not be identical. As one non-limiting example, one of the anode and cathode half-cells may have a plurality of flow areas and the other may have one flow area or a different number of flow areas than the other half-cell.

In one non-limiting embodiment of the present disclosure, the width to length ratio of each flow area or reaction zone is in the range of 2:1 to 100:1. In another embodiment, the number of electrolyte flow areas or reaction zones in the anolyte or catholyte or both is in the range of 2 to 100.

Other embodiments for half-cell design are also within the scope of the present disclosure to mitigate scale-up effects by delivering uniform electrolyte flow rates and flow distances. In the illustrated embodiment of FIG. 12, the catholyte half-cell 264 includes a flow pattern cut in the carbon felt 284 (or other suitable material) to direct electrolyte flow from a common cell inlet 282 through multiple flow paths in the felt 284. The flow pattern is designed to maintain consistent flow speed and distance as electrolyte flows through and around the porous felt 284 to a common cell outlet 286. As can be seen in FIG. 12, the flow channels 270 include non-continuous slots 296 in the felt 284 to drive the electrolyte through the reaction zones 270 in the carbon felt 284.

The configuration of the illustrated embodiment of FIG. 12 is designed for consistent flow distance for the electrolyte through all flow areas 270, the flow distance being less than the distance of the shortest dimension of the catholyte cell 264. In the illustrated embodiment of FIG. 12, the flow distance is about ¼ of the length of the catholyte and anolyte channels 264 and 266 (accounting for the non-reaction area distribution zones).

In the illustrated embodiment, at least a portion of the flow slots 296 are parallel to one another. However, in other embodiments, the flow slots 296 may not be in a parallel configuration.

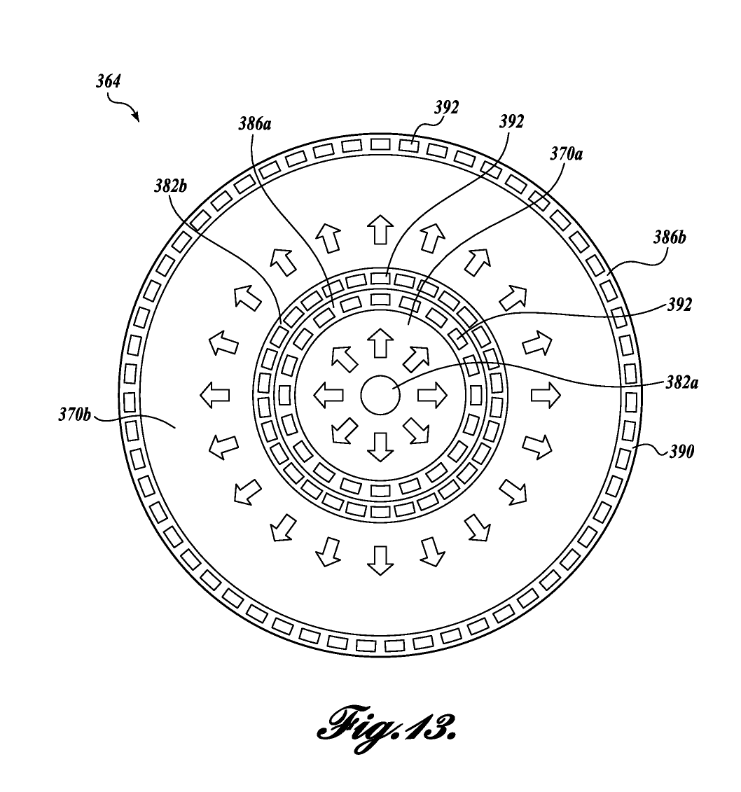

In the illustrated embodiment of FIG. 13, a cathode half-cell 364 for an electrochemical cell is provided. In the illustrated embodiment of FIG. 13, the half-cell 364 has a circular cross-section. In this embodiment, the electrochemical cell has a radius and the electrolyte flow distance in each of the electrolyte flow areas is a portion of the radius of the electrochemical cell. The half-cell 364 includes a first cell inlet electrolyte distribution zone 382a at the center of the circle, and a first cell outlet electrolyte distribution zone 386a radially distanced from the first inlet zone 382a. The half-cell 364 includes a second cell inlet electrolyte distribution zone 382a adjacent the first outlet zone 386a, and a second cell outlet electrolyte distribution zone 386b radially distanced from the second inlet zone 382b. Carbon felt 384 may be included in the reaction zones 370.

While illustrative embodiments have been illustrated and described, it will be appreciated that various changes can be made therein without departing from the spirit and scope of the disclosure.

The embodiments of the disclosure in which an exclusive property or privilege is claimed are defined as follows:

1. An electrochemical cell, the cell comprising:
(a) a positive portion including a cathode and a catholyte half-cell and a negative portion including an anode and an anolyte half-cell, wherein at least one of the catholyte half-cell and the anolyte half-cell has a plurality of electrolyte flow areas; and
(b) an ion transfer membrane separating the positive portion and the negative portion.

2. The electrochemical cell of claim 1, wherein both of the catholyte half-cell and the anolyte half-cell have a plurality of electrolyte flow areas.

3. The electrochemical cell of claim 1, wherein at least a portion of the plurality of electrolyte flow areas are in parallel configuration.

4. The electrochemical cell of claim 1, wherein each of the plurality of flow areas is in fluidic contact with a portion of the cathode or anode and a portion of the ion transfer membrane.

5. The electrochemical cell of claim 1, wherein at least a portion of the plurality of electrolyte flow areas is defined by a frame structure.

6. The electrochemical cell of claim 5, wherein the frame structure extends from the anode or cathode to the ion transfer membrane in either the catholyte or anolyte half-cell.

7. The electrochemical cell of claim 5, wherein the frame structure is made from a non-conductive material.

8. The electrochemical cell of claim 1, wherein at least a portion of the plurality of electrolyte flow areas is defined by the shape of a porous material.

9. The electrochemical cell of claim 8, wherein the porous material is selected from the group consisting of carbon felt and carbon foam.

10. The electrochemical cell of claim 8, wherein the shape of the porous material is determined by slots or other cuts that are non-continuous.

11. The electrochemical cell of claim 1, wherein the electrochemical cell has a length and a width and the electrolyte flow distance in each of the electrolyte flow areas is a portion of the shortest of the length and/or width of the electrochemical cell.

12. The electrochemical cell of claim 1, wherein the electrochemical cell has a radius and the electrolyte flow distance in each of the electrolyte flow areas is a portion of the radius of the electrochemical cell.

13. The electrochemical cell of claim 1, wherein the plurality of electrolyte flow areas are fluidly separated from each other, each having discrete inlets and outlets.

14. The electrochemical cell of claim 1, wherein the plurality of electrolyte flow areas are not fluidly separated from each other.

15. The electrochemical cell of claim 1, wherein the inlets and outlets to the plurality of electrolyte flow areas are located inside the electrochemical cell.

16. The electrochemical cell of claim 1, wherein the inlets and outlets to the plurality of electrolyte flow areas are located outside the electrochemical cell.

17. The electrochemical cell of claim 1, wherein the width to length ratio of each electrolyte flow area is in the range of 2:1 to 100:1.

18. The electrochemical cell of claim 1, wherein the number of electrolyte flow areas in the catholyte flow chamber or the anolyte flow chamber is in the range of 2 to 100.

19. An electrochemical cell, comprising:
(a) a positive portion including a cathode and at least one catholyte flow area;
(b) a negative portion including an anode and at least one anolyte flow area;
(c) an ion transfer membrane separating the catholyte and anolyte half-cells, wherein at least one of the catholyte and anolyte half-cells includes a plurality of electrolyte flow areas; and
(d) at least one positive current collector in contact with the cathode and at least one negative current collector in contact with the anode.

20. An electrochemical stack including at least first and second electrochemical cells, each electrochemical cell comprising:
(a) a positive portion including a cathode and at least one catholyte flow area;
(b) a negative portion including an anode and at least one anolyte flow area; and
(c) an ion transfer membrane separating the catholyte and anolyte half-cells, wherein at least one of the catholyte and anolyte half-cells includes a plurality of electrolyte flow areas.

21. The electrochemical stack of claim 20, further comprising an anolyte delivery manifold configured to distribute liquid anolyte to the first and second electrochemical cells.

22. The electrochemical stack of claim 20, further comprising an anolyte return manifold configured to accept liquid anolyte after passing through the first and second electrochemical cells.

23. The electrochemical stack of claim 20, further comprising a catholyte delivery manifold configured to distribute liquid catholyte to the first and second electrochemical cells.

24. The electrochemical stack of claim 20, further comprising a catholyte return manifold configured to accept liquid catholyte after passing through the first and second electrochemical cells.

25. The electrochemical stack of claim 20, wherein the first and second electrochemical cells are electrically connected in series.

26. The electrochemical stack of claim 20, wherein the first and second electrochemical cells are arranged fluidically in parallel.

27. A method of operating an electrochemical cell, the method comprising:
(a) flowing catholyte in a catholyte half-cell and flowing anolyte in an anolyte half-cell, wherein at least one of the catholyte and anolyte flow areas includes a plurality of electrolyte flow areas;
(b) separating the catholyte and anolyte flow areas of the catholyte and anolyte half-cells using an ion transfer membrane; and
(c) collecting current from the electrochemical cell.
